(19) United States
(12) Patent Application Publication
(10) Pub. No.: US 2025/0200556 A1
(43) Pub. Date: Jun. 19, 2025

(54) SYSTEMS AND METHODS FOR URL-BASED VIRTUAL CARD NUMBER GENERATION AND USE

(71) Applicant: Capital One Services, LLC, McLean, VA (US)

(72) Inventors: Joshua EDWARDS, Philadelphia, PA (US); Kevin OSBORN, Newton Highlands, MA (US); Leeyat Bracha TESSLER, Arlington, VA (US); Renee GILL, New York, NY (US)

(73) Assignee: Capital One Services, LLC, McLean, VA (US)

(21) Appl. No.: 18/538,450

(22) Filed: Dec. 13, 2023

(51) Int. Cl. G06Q 20/34; G06Q 20/40

(52) U.S. Cl. CPC G06Q 20/351; G06Q 20/4014

(57) ABSTRACT

A device may receive a VCN generation request comprising a primary account number (PAN) and an approved URL. A device may generate a VCN based on the PAN, the VCN being associated with the approved URL. A device may receive a VCN use request from an external entity, the VCN use request comprising the VCN. A device may receive a use request URL associated with the VCN use request. A device may compare the use request URL to the approved URL. A device may provide a VCN use decision based on the comparing the use request URL to the approved URL, the VCN use decision including a VCN use authorization or a VCN use denial.

### TECHNICAL FIELD

Various embodiments of the present disclosure relate generally to virtual card numbers (VCN), and more particularly, to systems and methods for generating one or more uniform resource locator (URL) specific VCNs and/or authorizing interactions based on URL-specific VCNs.

### BACKGROUND

Users often use one or more certification sources (e.g., payment mechanisms) such as credit cards, debit cards, or the like, to make purchases such as online purchases via merchant websites and applications. There has been an increase in fraud and/or theft related to certification sources. Such fraud and/or theft is often related to a third party obtaining access to payment mechanisms (e.g., credit card numbers). Such access may be obtained as a result of a user using a payment mechanism for a purchase in a manner where the third party can capture and/or use information associated with the payment mechanism. To prevent this fraud or theft, the user may use a VCN to make the purchase. However, this situation may be manipulated by the third person. For example, where the purchase was made on behalf of the third party, the third party may receives the purchase showing a list of items, requesting a card be generated, and then changing the items after the card is generated.

The present disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for virtual card number (VCN) generation and use.

In some aspects, the techniques described herein relate to a method for binding a virtual card number (VCN) to a uniform resource locator (URL) of a website, the method including: receiving a VCN generation request including a primary account number (PAN) and an approved URL; generating a VCN based on the PAN, the VCN being associated with the approved URL; receiving a VCN use request from an external entity, the VCN use request including the VCN; receiving a use request URL associated with the VCN use request; comparing the use request URL to the approved URL; and providing a VCN use decision based on the comparing the use request URL to the approved URL, the VCN use decision including a VCN use authorization or a VCN use denial.

In some aspects, the techniques described herein relate to a method for secure virtual card number (VCN) use, the method including: receiving a VCN use request from an external entity, the VCN use request including a VCN generated based on a primary account number (PAN) and associated with an approved website uniform resource locator (URL); receiving a requested website URL associated with the VCN use request; comparing the requested website URL to the approved website URL associated with the VCN; and providing a VCN use decision based on the comparing the use request URL to the approved URL, the VCN use decision including a VCN use authorization or a VCN use denial.

In some aspects, the techniques described herein relate to a method for secure virtual card number (VCN) use, the method including: receiving, at a user device, an indication to initiate a VCN based transaction with an external entity; providing a VCN in response to receiving the indication, the VCN generated based on a VCN generation request including a PAN and an approved website uniform resource locator (URL); providing a requested website URL based on a user input to the user device; and receiving a VCN use decision based on the comparing the use request URL to the approved URL, the VCN use decision including a VCN use authorization or a VCN use denial.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary setting for virtual card number (VCN) implementation, according to one or more embodiments.

FIG. 2 depicts an environment for VCN implementation, according to one or more embodiments.

FIG. 3 depicts a flowchart for determining VCN authorizations, according to one or more embodiments.

FIG. 4 depicts a flow diagram for training a machine learning model, according to one or more embodiments.

FIG. 5 depicts an example of a computing device, according to one or more embodiments.

### DETAILED DESCRIPTION OF EMBODIMENTS

According to certain aspects of the disclosure, systems and methods are disclosed for use of a virtual card number (VCN), and more particularly, to systems and methods for generating one or more uniform resource locator (URL)-specific VCNs and/or authorizing interactions based on URL-specific VCNs.

The techniques disclosed herein provide technical benefits including automated secure access to one or more certification mechanisms (e.g., payment mechanisms such as credit cards, debit cards, charge cards, credit accounts, debit accounts, etc.) without transmitting certification mechanism credentials (e.g., primary account number(s) (PANs)), automated security verification, risk-based registration, and secure checkouts. Technical effects of the techniques disclosed herein include securely generating VCNs based on corresponding PANs that pair with specific URLs, modifying one or more databases based on VCN generation, automatically authenticating VCNs based on URL mapping, and denying unauthorized use of VCNs. As disclosed herein, VCNs may be generated by tokenizing and/or encrypting a PAN, associating a URL with the VCNs, retrieving account identifiers based on the tokenized and/or encrypted PAN, generating reference identifiers, and conducting a risk analysis. A user may trigger VCN generation via a secure account (e.g., a user account, an account associated with a PAN, a financial account, an event based account, etc.) portal, where the trigger results in one or more of a URL association process, a PAN association process, and/or the like. A generated VCN may be used for transaction authentication based on URL verification, as discussed herein. Accordingly, a technical effect of generating and/or using a VCN includes securely using a PAN without the PAN being provided by the user and/or being received by a source. This technical effect has an effect on a transaction process of securely authorizing transactions without risk of PAN distribution to fraudulent parties.

For example, a user may desire to provide a VCN to a third party to make an online purchase using the user's account, without the user being required to share user account information such as the PAN with the third party. In some non-limiting examples, the user may be a parent and the third party may be a child of the parent, or the user may be a gift giver and the third party may be a gift recipient. As described below, the user may connect via a user device, such as a personal computer or smartphone via a web browser or app or other portal, to an external entity, such as the website of an online merchant, or to a secure entity, such as their banking institution, to generate a VCN associated with their PAN, the VCN being bound to a specified and approved URL associated, for example, with an approved online shopping cart containing items determined by the user. For example, the items in the shopping cart may be furniture for a college-age child's dormitory or a specific set of gifts for a gift recipient. The user may then transmit or otherwise communicate the approved VCN and the approved URL to the third party. The third party may use a user device to then transmit a VCN use request to an external entity and/or a secure entity. The user device may be the same as or different from the user device the first user used to generate the VCN request. Transmission of the VCN use request may, for example, take the form of accessing the approved URL and requesting the transaction to be completed and for the items in the approved shopping cart to be purchased and charged to the PAN associated with the VCN. As such, a URL-bound VCN allows for a third party to securely complete a transaction approved by a first user and charged to the PAN associated with the VCN. If the third party were to amend the items in the shopping cart, the URL would necessarily be altered and the VCN would not function for the amended transaction. As such, a third party may not add items to a shopping cart that were not previously approved by the first user and part of the VCN that the method is binding to the URL.

The technical effects provided by the techniques disclosed herein include evoking and updating database structures to generate and/or use VCNs. Such database structures are traditionally configured to store and/or access PANs, resulting in a security risk. However, techniques provided herein can be used to implement VCN-based authentication by evoking and/or updating database structures to authorize transactions without PANs (e.g., on a URL-specific basis). For example, associating a URL for VCN use provides security effects by limiting use of the VCN and further adds security controls based on automated rejection of VCN use external to the associated URL. Accordingly, both the access to such database structures and the information stored and/or accessed using such database structures require the database structures to operate in a new way.

As disclosed herein, secure access to one or more payment mechanisms may be provided by registering a user account and a PAN associated with the user account for VCN use for a specific URL. The registration and/or use of VCNs may be implemented via one or more of an external gateway, a registration serverless function (e.g., a registration lambda function), an authorization serverless function (e.g., an authorization lambda function), a dynamic database, a token service, a VCN service provider, and/or a risk module.

VCNs, as used herein, provide a secure way to transact with sources using source portals (e.g., source point-of-sale devices, source websites, source applications, source extensions, etc.). Such secure transactions may be facilitated by using VCNs without disclosure, transmission, and/or use of PANs that can be otherwise used by a fraudulent entity. A VCN may be linked to a PAN and/or a user account as well as a given URL (e.g., a URL for the shopping cart of an online merchant), such that a given VCN may be authorized for use based on the given URL, mitigating the risk of a fraudulent entity using a user's PAN at any other URL. Accordingly, techniques disclosed herein add one or more layers of protection when using certification mechanisms.

VCNs generated in accordance with the techniques disclosed herein may be generated specifically for a given URL. A VCN generated in accordance with the techniques disclosed herein may be immutably associated with a given URL such that the association between the VCN and the given URL may not be modified by user or entity action. Such immutability may provide a layer of security currently not available to users.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

Terms like “source,” “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser” or “extension” may be used interchangeably with other terms like “program,” “electronic application,” or the like, and generally encompasses software that is configured to interact with, modify, override, supplement, or operate in conjunction with other software.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

A secure account may be any account that is associated with a secure entity and one or more users and includes information about the one or more users. For example, a secure account may be an account associated with a certification mechanism (e.g., payment mechanisms such as credit cards, debit cards, charge cards, credit accounts, debit accounts, etc.). A secure account may be accessed using credentials such as, for example, login credentials, biometric credentials, or the like. As further disclosed herein, features associated with a secure account may be accessed using an external account.

An external entity may be or may include a user-facing entity such that a user may interact with an external entity interface. An external entity interface may be a web browser, an extension (e.g., a browser extension), a website, an operating system, an application, or the like. A user may transact with one or more sources (e.g., merchants, brands, organizations, marketplaces, etc.) using an external device, as further disclosed herein. Such transactions may take place at a given URL (e.g., a URL associated with a given merchant). The external entity may communicate with a secure entity via an external gateway. The secure entity may be an entity that hosts, controls, and/or has access to a secure account.

A user may register use of a VCN at a secure entity, by requesting the registration of the use via the secure entity or via the external entity. For example, a user may register use of a VCN using a secure entity portal after accessing a secure account via the secure entity portal. The user may access the secure account using credentials such as, for example, login credentials, biometric credentials, or the like.

A user may register use of a VCN using an external entity portal configured to receive VCN registration requests. Alternatively, the user may register use of a VCN via a source portal (e.g., a source website, a source application, a source application programming interface (API), etc.) accessed using an external entity platform (e.g., an external entity browser, an external entity application, an external entity operating system, an external entity API, etc.). For example, the user may direct an interface (e.g., an application, browser, etc.) to a source website using an external entity browser. As another example, a user may direct to a source application using an external entity operating system.

According to implementations of the disclosed subject matter, a user may trigger a registration request for registering use of a VCN associated with a PAN associated with the user. The user may provide the PAN via an external entity portal or via a source portal. The user may further provide URL information (e.g., a URL for the merchant shopping cart) for a target URL to be associated with the VCN. The URL information may be provided as or may be converted into a URL identifier. The URL identifier may be the full URL, specified portions of the URL, or metadata associated with the URL.

According to implementations of the disclosed subject matter, the URL information may be provided by a user (e.g., via user input) or may be determined automatically (e.g., by the secure entity), as further discussed herein.

According to implementations of the disclosed subject matter, a time value may be associated with the VCN. The time value may correspond to one or more times (e.g., one or more ranges of time) associated with use of the VCN. As further discussed herein, VCN use may be authorized based on the time value. The time value may be provided by a user or may be determined automatically (e.g., by the secure entity), as further discussed herein.

According to implementations of the disclosed subject matter, one or more rules may be associated with the VCN. The one or more rules may correspond to one or more actions, properties, or characteristics associated with use of the VCN. As further discussed herein, VCN use may be authorized based on the one or more rules. The one or more rules may be provided by a user or may be determined automatically (e.g., by the secure entity), as further discussed herein.

A URL-based VCN may be generated based on the URL identifier and may further be generated based on one or more of the time value and/or the one or more rules. The URL-based VCN may be provided to the user and/or may be associated with a user account (e.g., the secure account).

According to implementations of the disclosed subject matter, a VCN use request based on a URL-based VCN may be received. The VCN use request may include URL data. The URL data may be authenticated (e.g., by the secure entity) that receives the VCN use request. The VCN use request may include the VCN, the URL data, and/or transaction data associated with the VCN use request. For example, the VCN may be provided from a source (e.g., a merchant) to a VCN use authenticating entity (e.g., the secure account). The source may initiate a transaction at a source portal (e.g., for a purchase of a good, a purchase of a service, a subscription, etc.). Transaction data may be generated based on the initiation of the transaction at the source portal. The transaction data may be generated by the source, a transaction processor (e.g., a certification mechanism network, a financial institution, etc.), or the like, or a combination thereof. The transaction data may include transaction identifiers, encrypted data, or the like and may be or may include a hash value.

The URL data associated with the VCN use request may be compared to the URL identifier to determine an overlap, a match, or an association. If the comparison results in a confirmation that the URL data maps to the URL identifier, then the VCN use may be authorized with respect to the URL data. The approved authorization may indicate that the URL data provided in the VCN use request is associated with the URL identifier. Additionally, a timestamp associated with the VCN use request may be compared to the time value to determine an overlap, a match, or an association. If the comparison results in a confirmation that the timestamp maps to the time value, then the VCN use may be authorized with respect to the URL data. Additionally, one or more rule properties associated with the VCN use request may be compared to the one or more rules to determine an overlap, a match, or an association. If the comparison results in a confirmation that the rule properties map to the one or more rules, then the VCN use may be authorized with respect to the one or more rules. A VCN use authorization may be generated based on one or more of the URL, time, and/or rule based authorizations. Alternatively, a VCN use denial may be generated based on the lack of one or more of the URL, time, and/or rule based authorizations.

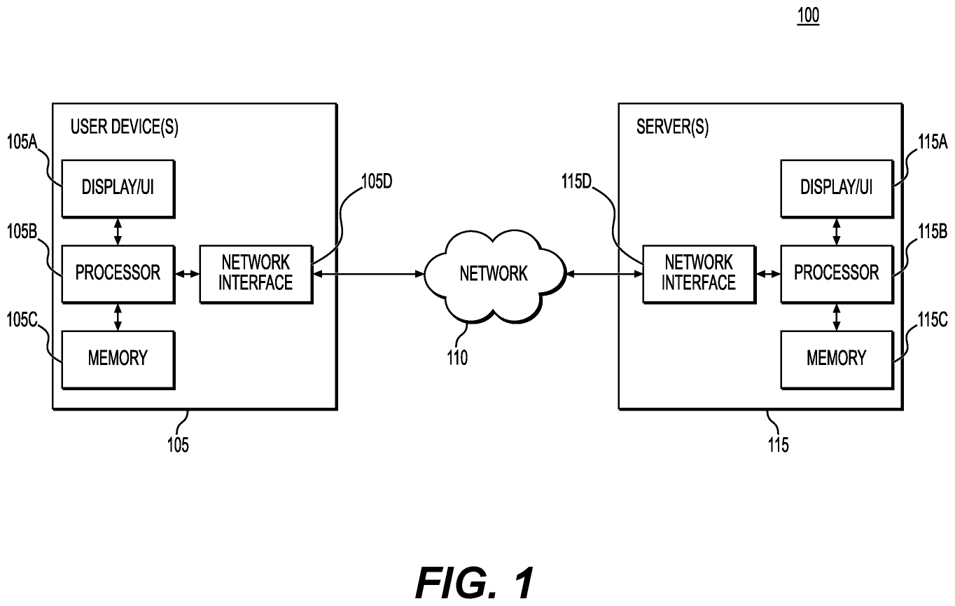

FIG. 1 depicts an exemplary setting 100 which may be used with the techniques presented herein. The setting 100 may include one or more user device(s) 105 (hereinafter “user device 105” for ease of reference), a network 110, one or more server(s) 115 (hereinafter “server 115” for ease of reference). While only one of each of user device 105 and server 115 are depicted, the disclosure is not limited to one of each and two or more of each of user device 105 and server 115 may be implemented in accordance with the techniques disclosed herein.

User device 105 may be used to, for example, access a secure account or portal, access an external entity account, portal, or platform, access a source portal, or the like. User device 105 may be used to trigger a VCN generation, to initiate a transaction at a source, or the like. Server 115 may be a secure entity server (e.g., may host a secure account, a secure entity system, etc.), an external entity server (e.g., may host an external account, an external entity system, etc.), a source server (e.g., a brand server), or the like.

The user device 105 and the server 115 may be connected via the network 110, using one or more standard communication protocols. The network 110 may be one or a combination of the Internet, a local network, a private network, or other network. The user device 105 and the server 115 may transmit and receive messages from each other across the network 110, as discussed in more detail below.

The server 115 may include a display/UI 115A, a processor 115B, a memory 115C, and/or a network interface 115D. The server 115 may be a computer, system of computers (e.g., rack server(s)), or a cloud service computer system. The server 115 may execute, by the processor 115B, an operating system (O/S). The memory 115C may also store one or more instances of a machine learning model (e.g. an authentication machine learning model, etc.), instructions to perform operations, or the like. The display/UI 115A may be a touch screen or a display with other input systems (e.g., mouse, keyboard, etc.) for an operator of the server 115 to control the functions of the server 115. The network interface 115D may be a TCP/IP network interface for, e.g., Ethernet or wireless communications with the network 110.

User device 105 may include a display/UI 115A, a processor 105B, a memory 105C, and/or a network interface 105D. User device 105 may be an electronic and/or mobile device, such as a cell phone, a tablet, a laptop, a computer, a wearable device, a terminal, etc. User device 105 may execute, by the processor 105B, an operating system (O/S), a machine learning training component, a portal, a platform, or the like. One or more components shown in FIG. 1 may generate or may cause to be generated one or more graphic user interfaces (GUIs) based on instructions/information stored in memory 105C, instructions/information received from server 115, and/or one or more user devices 105. The GUIs may be portal interfaces, platform interfaces, mobile application interfaces, for example.

In various embodiments, the network 110 may be a wide area network (“WAN”), a local area network (“LAN”), personal area network, or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the one or more components of exemplary setting 100 may one or more of generate, store, train, or use a machine learning model or its applicable components or attributes such as nodes, model states, weights, layers, biases, or the like. The exemplary setting 100 or one of its components may include a machine learning model and/or instructions associated with the machine learning model, e.g., instructions for generating a machine learning model, training the machine learning model, using the machine learning model, etc. The exemplary setting 100 or one of its components may include instructions for retrieving data, adjusting data, e.g., based on the output of the machine learning model, and/or operating a display to output data, e.g., as adjusted based on the machine learning model. The exemplary setting 100 or one of its components may include, provide, and/or generate training data.

In some embodiments, a system or device other than the components shown in exemplary setting 100 may be used to generate and/or train the machine learning model. For example, such a system may include instructions for generating the machine learning model, the training data and ground truth, and/or instructions for training the machine learning model. A resulting trained machine learning model may then be provided to exemplary setting 100 or one of its components. The machine learning model may be stored in any applicable location such as in memory 115C or memory 105C, in a location other than setting 100 in operable communication with setting 100, or the like.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. Alternatively or in addition, unsupervised learning and/or semi-supervised learning may be used to train a machine learning model.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine learning model, e.g., compare the output of the trained model with the ground truth for that portion of the training data to evaluate an accuracy of the trained model. The training of the machine learning model may be configured to cause the machine learning model to learn associations between training data (e.g., secure user data) and ground truth data, such that the trained machine learning model is configured to determine an output in response to the input data based on the learned associations.

In various embodiments, the variables of a machine learning model may be interrelated in any suitable arrangement in order to generate the output. For example, in some embodiments, the machine learning model may include image-processing architecture that is configured to identify, isolate, and/or extract features, geometry, and/or structure. For example, the machine learning model may include one or more convolutional neural networks (“CNN”) configured to identify features in the data, and may include further architecture, e.g., a connected layer, neural network, etc., configured to determine a relationship between the identified features in order to determine a location in the data.

In some instances, different samples of training data and/or input data may not be independent. Thus, in some embodiments, the machine learning model may be configured to account for and/or determine relationships between multiple samples.

For example, in some embodiments, the machine learning models referenced herein may include a CNN, or Recurrent Neural Network (“RNN”). Generally, RNNs are a class of feed-forward neural networks that may be well adapted to processing a sequence of inputs. In some embodiments, the machine learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of items (e.g., words, letters, time series, images) as input, and generate another sequence items (e.g., where they may convert sequences of one domain to sequences of another domain). For example, a Seq2Seq model may, for example, be configured to receive image data and output location data associated with the received image data (e.g., a location where an image was captured).

Although depicted as separate components in FIG. 1, it should be understood that a component or portion of a component in the exemplary setting 100 may, in some embodiments, be integrated with or incorporated into one or more other components. For example, a portion of the display/UI 115A may be integrated into the user device 105 or the like. In another example, the server 115 may be integrated in a data storage system. In some embodiments, operations or aspects of one or more of the components discussed above may be distributed amongst one or more other components. Any suitable arrangement and/or integration of the various systems and devices of the exemplary setting 100 may be used.

Further aspects of the machine learning model and/or how it may be utilized to authorize an external account, etc. are described herein. In the following methods, various acts may be performed or executed by a component from FIG. 1, such as the server 115, the user device 105, or components thereof. However, it should be understood that in various embodiments, various components of the exemplary setting 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

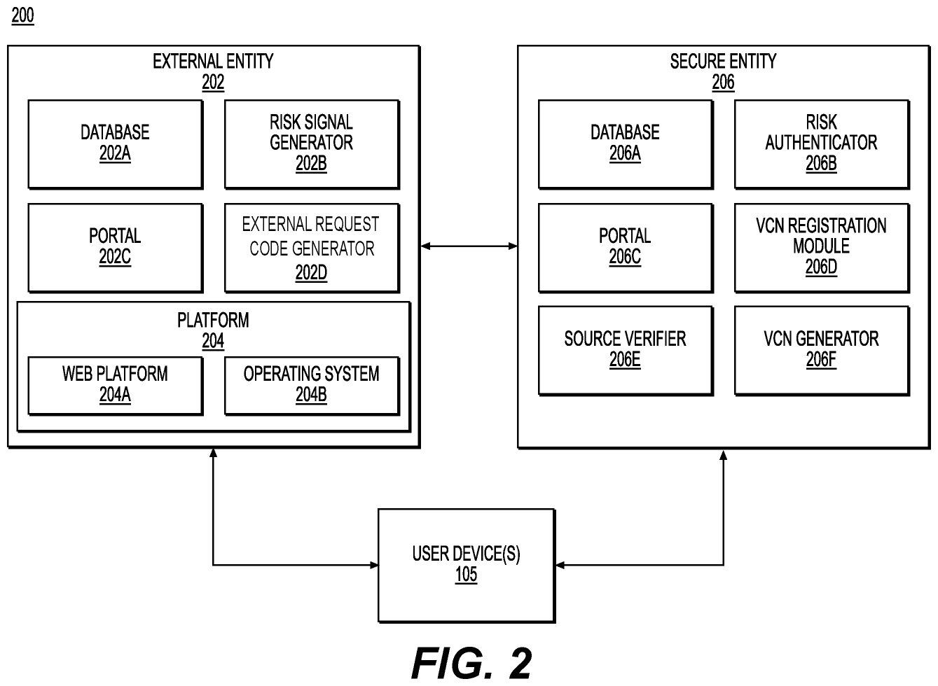

FIG. 2 depicts an exemplary environment 200 which may be used with the systems and techniques presented herein. External entity 202 may include, provide, communicate with, or be associated with an external entity database 202A, risk signal generator 202B, external entity portal 202C, external request code generator 202D, and/or platform 204 which may include web platform 204A and/or operating system 204B. It will be understood that external entity 202 may include more or less components than those shown in exemplary environment 200.

Secure entity 206 may include, provide, communicate with, or be associated with a secure entity database 206A, a risk authenticator 206B, a portal 206C, a VCN registration module 206D, a source verifier 206E, and/or a VCN generator 206F. It will be understood that external entity 202 may include more or less components than those shown in exemplary environment 200.

User device 105, as shown in FIG. 1, may communicate with external entity 202 and/or secure entity 206. External entity 202 may communicate with user device 105 and/or secure entity 206. Secure entity 206 may communicate with user device 105 and/or external entity 202. The communication referenced herein may be implemented in accordance with the communication discussed in reference to FIG. 1 (e.g., via network 110, via wired communication, etc.). One or more components shown in system environment 200 and/or any components associated with external entity 202, secure entity 206, and/or user device 105 may use, may include, or may be implemented using a remote or cloud component such as a cloud server, cloud database, or the like. Components of system setting 100 are further referenced herein.

According to implementations of the disclosed subject matter, a user may register for VCN use via an external entity 202 external entity portal 202C. The external entity 202 (e.g., an entity authorized to request registration of VCN use) may communicate with secure entity 206 to register VCN use. The external entity 202 may register VCN use based on data stored in database 202A, based on risk analysis conducted using risk signal generator 202B, an external request code generator 202D, and/or the like. For example, a user may trigger VCN registration via an external entity web platform 204 (e.g., a website, a browser, etc.) or external entity 202 operating system 204B (e.g., a mobile operating system). External entity 202 may initiate VCN registration via transmitting external code generated at external request code generator 202D. The external code may be provided to secure entity 206 (e.g., an entity authorized to approve VCN registration). The external code may be used to register a user's user account (e.g., an external entity account and/or secure entity account) for VCN use. Secure entity 206 VCN registration module 206D may authorize the VCN registration (e.g., based on a secure entity 206 risk analysis at risk authenticator 206B) for a PAN associated with the user. Secure entity 206 may transmit the VCN registration to external entity 202. A registration authentication may be generated confirming VCN registration for VCN use.

According to implementations of the disclosed subject matter, a user may register for VCN use via source entity 206 secure entity portal 206C. The secure entity 206 (e.g., an entity authorized to register VCN use) may register VCN use based on data stored in database 206A, based on risk analysis conducted using risk signal generator 202B, an external request code generator 202D, and/or the like. For example, a user may access a secure user account associated with secure entity 202. The user may provide credentials to log into or otherwise access the secure user account via a secure entity portal 206C (e.g., via a webpage, an application, etc.). Secure entity 206 VCN registration module 206D may authorize the VCN registration (e.g., based on a secure entity 206 risk analysis at risk authenticator 206B). Secure entity 206 may designate a given PAN associated with the user as registered for VCN use. A registration authentication may be generated confirming VCN registration for VCN use.

According to implementations of the disclosed subject matter, URL-based VCNs may be generated once a registration authentication for PAN has been generated. The registration authentication may designate the PAN as a PAN approved for VCN use, as disclosed herein. VCNs may provide a secure way to transact with sources (e.g., brands, companies, sellers, marketplaces, etc.) using source portals (e.g., source point of sale source devices). Such secure transactions are facilitated by using VCNs without disclosure, transmission, and/or use of PANs to or by a source, such that the likelihood of a fraudulent entity obtaining the PAN is eliminated or severely mitigated. A VCN may be linked to a PAN and/or a user account as well as a given source, such that a given VCN may be authenticated for use for a given source, mitigating the risk of a fraudulent entity obtaining the PAN and eliminating the risk that of a fraudulent entity using the VCN at any other source.

A user may register a PAN and/or user account for VCN use, as discussed herein. The user may register a PAN for VCN use using an external entity platform, an external entity portal, or a secure entity portal, as discussed herein. Registering for VCN use may also be triggered at a source portal accessed via an external entity platform or an external entity portal. For example, a user may access a merchant's portal (e.g., a website, an application, etc.). From the merchant's portal, the user may provide a PAN for VCN generation, where the VCN is to be associated with the URL associated with the merchant's portal and optionally a specified shopping cart at the merchant's portal. A determination may be made regarding whether a user account or PAN associated with the user is registered for VCN use. For example, the event portal and/or respective servers may communicate with secure entity 206 to determine if a registration authentication associated with the PAN exists. If no account or PAN is registered for VCN use, then the user may be presented an option to register for VCN use. Alternatively, or in addition, if an account of PAN is registered for VCN use, the user may also be presented an option for VCN use for a different account or PAN. The external entity may facilitate the VCN use registration, in accordance with the techniques disclosed herein.

According to implementations of the disclosed subject matter, once an account or PAN is registered for VCN use, a URL-specific VCN associated with the PAN may be generated.

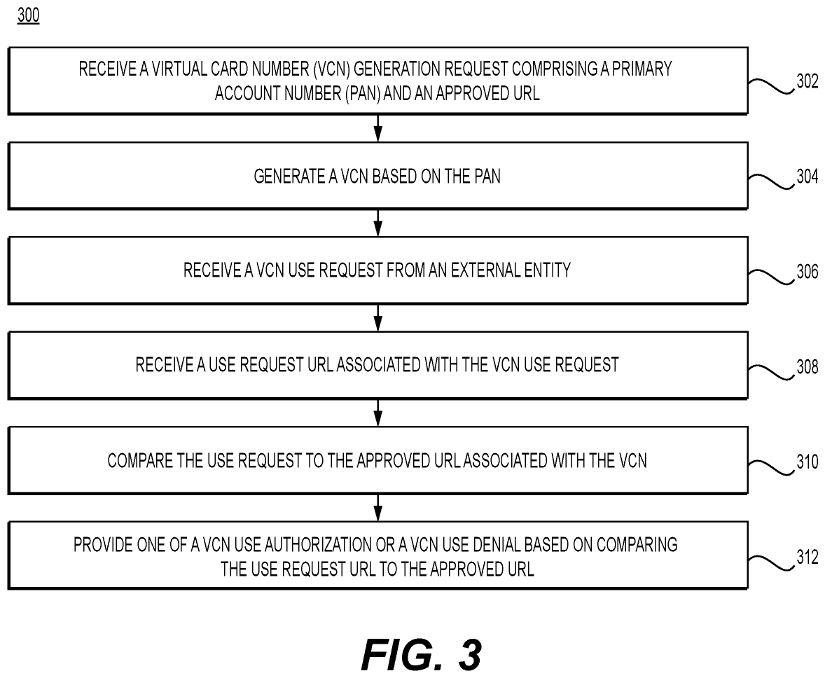

FIG. 3 depicts a flowchart 300 for generating a VCN based on a certification mechanism identifier and a URL identifier. In flowchart 300, a VCN generation request may be received at VCN registration module 206D of secure entity 206 at step 302. VCN registration module 206D may be configured to receive the VCN generation request via external gateway, for example. The VCN generation request may be generated at a source portal or external entity portal (e.g., merchant's portal), as discussed herein.

The VCN generation request may include the PAN or a user account associated with one or more PANs. The VCN generation request may include a registration identifier (e.g., corresponding to a PAN) to be associated with the VCN. The registration identifier may be determined based on an indication or user input selecting a PAN from one or more PANs of a user account that are registered for VCN use. The registration identifier may distinguish one PAN associated with a user account from another PAN associated with the user account.

The VCN generation request may further include a URL identifier associated with an approved URL. For example, a user may provide URL information to associate with the VCN. The URL information may be a complete or partial URL, metadata associated with a URL, or the like, and may identify, for example, the shopping cart of an online merchant. The user may add or delete items from a shopping cart of an online merchant, and the completed shopping cart may be associated with the URL. Alternatively, the URL information may be provided by an external entity 202, such as the merchant. For example, a user may indicate that the VCN generation request is associated with a given transaction or shopping cart. The URL associated with the given transaction may be received or determined based on the merchant name, a merchant identifier, a search (e.g., a database search) for the merchant, etc. and associated with the specified, approved URL. The VCN is then bound to the approved URL, meaning that authorization for use of the VCN is dependent on the VCN being used at the approved URL or a match thereof, as further described below.

As an illustrative example, a user may access a secure entity portal 206C and request VCN generation. The user may add or delete items to a shopping cart of an online merchant and partially complete the transaction to arrive at a URL for the shopping cart. This URL is then the approved URL associated with the VCN generation request via the secure entity portal 206C.

The VCN generation request may further include external risk signals associated with the VCN generation request. The external risk signals may be similar to the external risk signals discussed herein in reference to the VCN registration request and may be generated by external entity 202 (e.g., merchant) or secure entity 206.

At step 304, a VCN may be generated (e.g., at secure entity 206 via VCN generator 206F). The VCN may be generated based on the PAN and the URL identifier for the approved URL. The VCN may be associated with both the PAN and the URL identifier such that the VCN may only be used at a URL corresponding to the URL identifier. The VCN may be stored at database 206A and the URL associated with the URL identifier for the approved URL may be relationally correlated with the VCN.

The VCN generated at step 304 may be provided from secure entity 206 to external entity 202, a user device, and/or an external device, as further discussed herein. External entity 202 may receive the VCN and may associate the VCN with an external entity user account. Accordingly, the external entity may provide the VCN as a certification mechanism option when the user initiates a transaction at a URL associated with the URL identifier.

As an illustrative example, the VCN generated at step 304 may be associated with the PAN such that the user may provide the VCN instead of the PAN when conducting a transaction (e.g., a transaction at a URL associated with the URL identifier). The VCN may be associated with a user account (e.g., a digital payment account). The VCN may be stored at a user device (e.g., a user's mobile phone or a third party's mobile phone) such that the user device may provide the VCN for conducting a transaction. The VCN may be associated with a third party account (e.g., an account associated with a third party user for use at a URL associated with the URL identifier). Accordingly, transactions initiated using the third party account (e.g., at the given URL) may utilize the VCN. The VCN may be stored at an external device such as a band, an electronic device, a keycard, a near field communication (NFC), a radio-frequency identifier (RFID) device, etc. The external device may be associated with the third party account such that a user may use the external device at the given event to initiate transactions.

According to implementations of the disclosed subject matter, once a VCN corresponding to a given PAN and a given URL identifier has been generated, the VCN may be used to conduct transactions at the URL associated with the URL identifier. A user may use user device 105, a third party account, and/or an external device to conduct a transaction at the URL associated with the URL identifier. The URL associated with the URL identifier may be an approved URL.

At step 306 of FIG. 3, a VCN use request may be received from a source entity for a VCN based transaction. For example, secure entity 206 may receive a VCN use request based on the user initiating a transaction using the VCN at the given source. Based on the VCN use request, a VCN source verification process may be initiated at secure entity 206. The VCN use request may include the VCN and transaction data associated with the VCN use request.

At step 308, URL data in the form of a use request URL associated with the VCN use request may be received and associated with the VCN use request. The URL data may be received as part of the VCN use request at step 306 or may be received separately from the VCN use request. The use request URL may be received by a third party device different from the user device that transmitted the VCN generation request. For example, a first user may use a first user device to transmit the VCN generation request comprising the PAN and an approved URL as described in step 302. The first user may be the primary account holder of a transaction card or account associated with the PAN, and the approved URL may be related to a shopping cart of a merchant comprising items for which the first user approves a purchase. The first user may provide the VCN associated with the PAN and the approved URL to a third party. The third party may use a second user device that may be the same as or different from the first user device to generate a VCN use request that may be transmitted through external entity 202 or directly from a user device 104 to secure entity 206. According to an implementation, a portion of the transaction data may be generated by a payment processor such as, but not limited to a certification card processing institution, a banking institution, or the like.

At step 310, the use request URL received at step 308 may be compared to the approved URL associated with the VCN received at step 302. A determination may be made whether the use request URL received at step 308 matches with the approved URL. A determination of a match may be based on an exact match of the entire URL, or may be based on specified portions of the URL, or metadata associated with the URL. If the URL includes query terms, a match may be based on the content of the query terms without regard for the order of the query terms. Some elements of the URL may be excluded in the determination of a match, such as the coding protocol (e.g., “http://” versus “https://”) or trailing slashes. Parsed URLs may be used in place of the complete URLs, and a match may be based on the parsed URL.

In some alternate implementations, the functions/acts noted in the steps of FIG. 3 can occur out of the order noted in the operational illustration. For example, two steps shown in succession can in fact be executed substantially concurrently or the steps can sometimes be executed in the reverse order, depending upon the functionality/acts involved. For example, steps 306 and 308 may occur before steps 302 and 304. A third party may transmit a VCN use request with an associated use request URL. A user may be notified of the VCN use request, and in response transmit a a VCN generation request comprising a PAN and approving the use request URL. This may be, for example, where the third party is a child of the user, and creates an online shopping cart comprised of one or more items, for example one pint of Brand A ice cream and one bag of brand X pasta. The user may receive the use request URL, i.e., the URL of the shopping cart, and approve the shopping cart, i.e., approve the URL. Alternatively, the process may be iterative, where the user removes an item or adds an item, and transmits the approved URL back to the third party. For example, the user may remove the one pint of Brand A ice cream and replace it with Brand B ice cream. Or the user may delete the Brand A ice cream from the shopping cart without replacing it. Alternatively, the user may keep the Brand A ice cream and Brand X pasta, and add ice cream cones and pasta sauce. In terms of URL, the user may edit the URL or URL identifiers before approval, and generate a VCN based on the approved URL for third party use. If the user edits the approved URL, steps 306 and 308 would be repeated so that in step 310, the comparison would result in a match. If the user does not edit the URL and the approved URL matches the original use request URL, the process may proceed directly to step 312 resulting in a VCN use authorization.

At step 312, a VCN use authorization may be provided based on the comparison at step 310. The VCN use authorization may be provided if the use request URL associated with the transaction matches the approved URL as determined in the comparison at step 310. Alternatively, at step 312, a VCN use denial may be provided based on the comparison at step 310. The VCN use denial may be provide if the use use request URL associated with the transaction does not match the approved URL.

According to an implementation of the disclosed subject matter, one or more rules associated with a given VCN may be received. The one or more rules may be received with the VCN generation request at step 302 of FIG. 3. The one or more rules may be automatically generated by external entity 202, secure entity 206, and/or may be provided based on user input. The rule may dictate use of one or more VCNs associated with a user such as, for example, maximum transaction amounts, type of source, frequency of use, or the like. Accordingly, a VCN generated in accordance with techniques disclosed herein may be associated with the one or more rules. When VCN use is triggered, as disclosed herein (e.g., at step 306 of FIG. 3), the VCN use may be filtered using the one or more rules such that use of the VCN may be allowed or blocked (e.g., at step 312) further based on the rule. The one or more rules discussed herein may be implemented at external entity 202 or secure entity 206.

According to an implementation of the disclosed subject matter, one or more time values associated with a given VCN may be received. The one or more time values may be received with the VCN generation request at step 302 of FIG. 3. The one or more time values may be automatically generated by external entity 202, secure entity 206, and/or may be provided based on user input. According to an implementation, the one or more time values may be automatically determined based on times associated with an event. Time values based on times associated with an event may include a buffer (e.g., a given amount of time before and/or after the times associated with the event). The buffer may be determined based on a machine earning model configured to output the buffer based on historical events (e.g., historical events matching a profile of a given event) or simulated events. The time values may dictate use of one or more VCNs associated with a user such as, time of transaction, time of event, and/or the like. Accordingly, a VCN generated in accordance with techniques disclosed herein may be associated with the one or more time values. When VCN use is triggered, as disclosed herein (e.g., at step 306 of FIG. 3), the VCN use may be filtered using the one or more time values such that use of the VCN may be allowed or blocked (e.g., at step 312) further based on the time values and the time associated with a transaction.

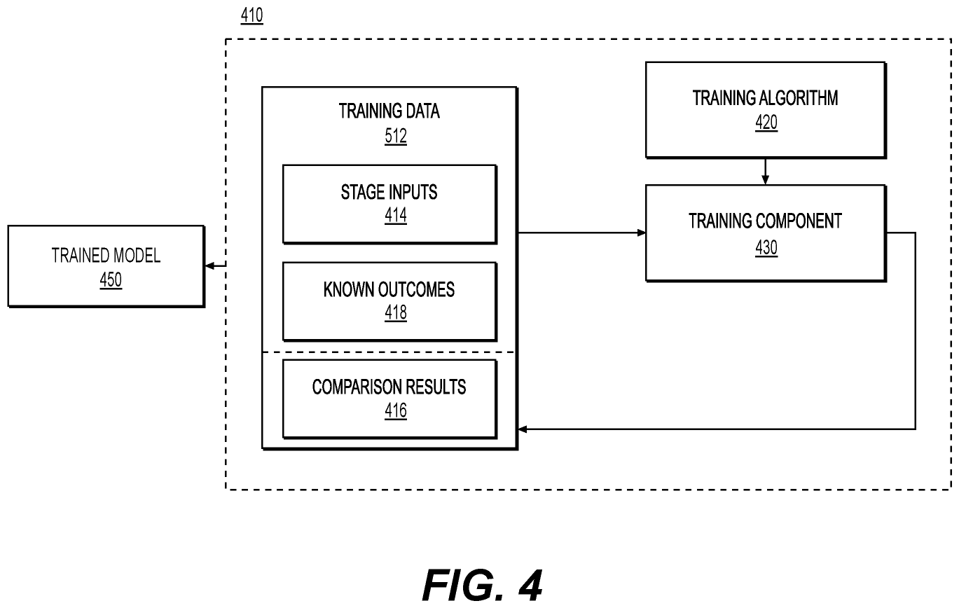

As disclosed herein, one or more implementations disclosed herein may be applied by using a machine learning model. A machine learning model as disclosed herein may be trained using one or more components or steps of FIGS. 1-3. As shown in flow diagram 410 of FIG. 4, training data 412 may include one or more of stage inputs 414 and known outcomes 418 related to a machine learning model to be trained. The stage inputs 414 may be from any applicable source including a component or set shown in the figures provided herein. The known outcomes 418 may be included for machine learning models generated based on supervised or semi-supervised training. An unsupervised machine learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine learning model 450. According to an implementation, the training component 430 may be provided comparison results 416 that compare a previous output of the corresponding machine learning model to apply the previous result to re-train the machine learning model. The comparison results 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 410 may be a trained machine learning model 450.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

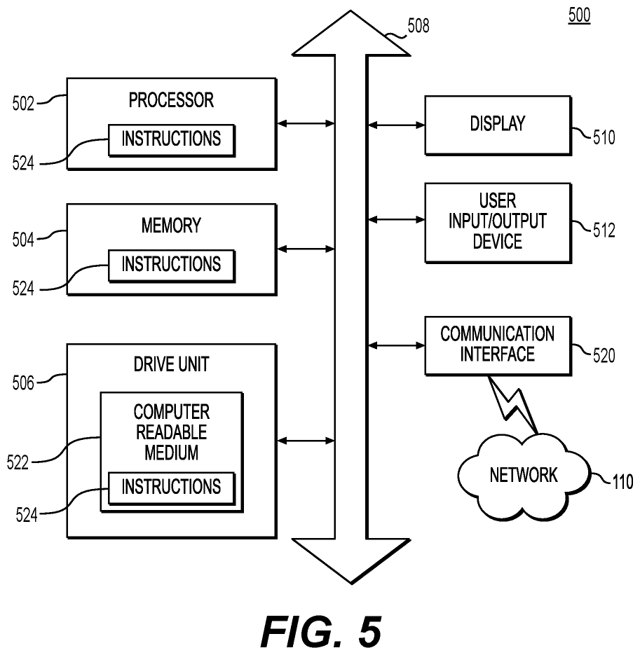

FIG. 5 is a simplified functional block diagram of a computer 500 that may be configured as a device for executing the methods disclosed here, according to exemplary embodiments of the present disclosure. For example, the computer 500 may be configured as a system according to exemplary embodiments of this disclosure. In various embodiments, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for binding a virtual card number (VCN) to a uniform resource locator (URL) of a website, the method comprising:
receiving a VCN generation request comprising a primary account number (PAN) and an approved URL;
generating a VCN based on the PAN, the VCN being associated with the approved URL;
receiving a VCN use request from an external entity, the VCN use request comprising the VCN;
receiving a use request URL associated with the VCN use request;
comparing the use request URL to the approved URL; and
providing a VCN use decision based on the comparing the use request URL to the approved URL, the VCN use decision including a VCN use authorization or a VCN use denial.

2. The method of claim 1, wherein the approved URL is for an approved shopping cart of an online merchant.

3. The method of claim 2, further comprising:
triggering the VCN use request based on communication from a user device to an external entity device associated with the external entity; and
receiving the use request URL in response to triggering the VCN use request.

4. The method of claim 3, wherein the use request URL comprises a requested shopping cart of the online merchant; and
comparing the use request URL to the approved URL comprises comparing the approved shopping cart to the requested shopping cart.

5. The method of claim 1, wherein the VCN generation request further comprises a time value and further comprising:
receiving a timestamp associated with the VCN use request;
comparing the time value to the timestamp; and
providing the one of the VCN use authorization or the VCN use denial further based on comparing the time value to the timestamp.

6. The method of claim 1, wherein the VCN generation request further comprises a rule and further comprising:
receiving transaction data associated with the VCN use request;
extracting a rule property associated with the rule from the transaction data;
comparing the rule property to the rule; and
providing the one of the VCN use authorization or the VCN use denial further based on comparing the rule property to the rule.

7. The method of claim 6, wherein the rule is generated by a secure entity or by a first user.

8. The method of claim 7, wherein the VCN generation request is received from a first user device associated with the first user.

9. The method of claim 6, wherein the rule is associated with first metadata in the approved URL and the rule property is associated with second metadata in the requested URL.

10. A method for secure virtual card number (VCN) use, the method comprising:
receiving a VCN use request from an external entity, the VCN use request comprising a VCN generated based on a primary account number (PAN) and associated with an approved website uniform resource locator (URL);
receiving a requested website URL associated with the VCN use request;
comparing the requested website URL to the approved website URL associated with the VCN; and
providing a VCN use decision based on the comparing the use request URL to the approved URL, the VCN use decision including a VCN use authorization or a VCN use denial.

11. The method of claim 10, wherein the VCN is generated based on a VCN generation request comprising the PAN and the approved website URL.

12. The method of claim 10, wherein providing one of the VCN use authorization or the VCN use denial is further based on comparing a VCN source identifier associated with the VCN to a transaction source identifier associated with the VCN use request.

13. The method of claim 10, wherein providing one of the VCN use authorization or the VCN use denial is further based on comparing a time value associated with the VCN to a timestamp associated with the VCN use request.

14. The method of claim 10, wherein providing the VCN use decision is further based on comparing a rule associated with the VCN to a rule property associated with the VCN use request.

15. The method of claim 14, wherein the rule is generated by a secure entity or by a first user.

16. The method of claim 14, wherein the rule is associated with first metadata in the approved website URL and the rule property is associated with second metadata in the requested website URL.

17. A method for secure virtual card number (VCN) use, the method comprising:
receiving, at a user device, an indication to initiate a VCN based transaction with an external entity;
providing a VCN in response to receiving the indication, the VCN generated based on a VCN generation request comprising a PAN and an approved website uniform resource locator (URL);
providing a requested website URL based on a user input to the user device; and
receiving a VCN use decision based on comparing the use request URL to the approved URL, the VCN use decision including a VCN use authorization or a VCN use denial.

18. The method of claim 17, wherein the indication to initiate the VCN based transaction is provided via one of the user input or an interaction between the user device and an external entity device associated with the external entity.

19. The method of claim 17, further comprising initiating the VCN based transaction using a primary user device, the initiating comprising causing the VCN to be stored at the user device.

20. The method of claim 17, wherein receiving a VCN use decision is further based on comparing a time value associated with the VCN to a timestamp associated with the VCN use request.
